(19) United States
(12) Patent Application Publication
(10) Pub. No.: US 2024/0248330 A1
(43) Pub. Date: Jul. 25, 2024

(54) OPTICAL DEVICE, OPTICAL TRANSMITTING DEVICE, AND OPTICAL RECEIVING DEVICE

(71) Applicant: FUJITSU OPTICAL COMPONENTS LIMITED, Kawasaki-shi (JP)

(72) Inventor: Masaki SUGIYAMA, Kawasaki (JP)

(73) Assignee: FUJITSU OPTICAL COMPONENTS LIMITED, Kawasaki-shi (JP)

(21) Appl. No.: 18/497,521

(22) Filed: Oct. 30, 2023

(30) Foreign Application Priority Data
Jan. 20, 2023 (JP) 2023-007448

(51) Int. Cl. G02F 1/025; G02F 1/03

(52) U.S. Cl. CPC G02F 1/025; G02F 1/0311; G02F 1/0316; G02F 2201/063

(57) ABSTRACT

An optical device includes a rib optical waveguide formed on a substrate, a P doped region formed in one of slab regions of the rib optical waveguide, an N doped region formed in the other one of the slab regions of the rib optical waveguide, a first electrode connected to the P doped region, a second electrode connected to the N doped region, and an optical absorption structure. The optical absorption structure implements optical absorption of signal light passing through the rib optical waveguide according to an electric current that flows between the first electrode and the second electrode, and makes, in the optical absorption, the signal light passing through an optical input portion of the rib optical waveguide lower in optical attenuation rate than the signal light passing through at least part of the rib optical waveguide, the part excluding the optical input portion.

### CROSS-REFERENCE TO RELATED APPLICATION

This application is based upon and claims the benefit of priority of the prior Japanese Patent Application No. 2023-007448, filed on Jan. 20, 2023, the entire contents of which are incorporated herein by reference.

### FIELD

The embodiments discussed herein are related to optical devices, optical transmitting devices, and optical receiving devices.

### BACKGROUND

With the recent increase in communication capacity, demand for optical fiber communication is on the rise. Development of optical devices typified by silicon photonics is thus being actively undertaken. Optical attenuators, such as a variable optical attenuator (VOA) that attenuates intensity of signal light transmitted through an optical waveguide according to an electric signal, have been known, for example, as such optical devices.

FIG. 18 is a schematic plan view of an example of a VOA. FIG. 19 is a schematic sectional view taken on a line A-A illustrated in FIG. 18. A VOA 100 has a Si substrate 121, a rib optical waveguide 102 formed on the Si substrate 121, and electrodes 103 connected to slabs 102D and 102E on both sides of the rib optical waveguide 102. The VOA 100 also has a cladding layer 122 formed on the Si substrate 121 and surrounding the rib optical waveguide 102 and the two electrodes 103.

The rib optical waveguide 102 has a core C made of Si and the slabs 102D and 102E on both sides of the core C. The core C and part of the slabs 102D and 102E form an optical waveguide 102A. The rib optical waveguide 102 has an optical input portion 102B and an optical output portion 102C. The optical input portion 102B is an input stage of the rib optical waveguide 102, the input stage being where signal light is input to the optical waveguide 102A. The optical output portion 102C is an output stage of the rib optical waveguide 102, the output stage being where the signal light is output from the optical waveguide 102A. A P doped region 111 that has been P doped is formed in the slab 102D that is one of the slabs 102D and 102E of the rib optical waveguide 102, and an N doped region 112 that has been N doped is formed in the other slab 102E. The optical waveguide 102A in an undoped region. The rib optical waveguide 102 has a PIN diode structure including the P doped region 111, the undoped optical waveguide 102A, and the N doped region 112.

The electrodes 103 include a first electrode 103A electrically connected to the P doped region 111 and a second electrode 103B electrically connected to the N doped region 112. The first electrode 103A is a signal electrode connected to a feeding pad 104 for application of voltage and the second electrode 103B is a ground electrode connected to a ground pad 105.

The feeding pad 104 in the VOA 100 is positioned near the center of the VOA 100, and the width of the first electrode 103A is the same as the width of the feeding pad 104. The ground pad 105 in the VOA 100 is positioned near the center of the VOA 100, and the width of the second electrode 103B is the same as the width of the ground pad 105.

In a case where a positive voltage is applied to the first electrode 103A from the feeding pad 104, an electric current flows from the first electrode 103A to the second electrode 103B. Therefore, the electric current flows through the rib optical waveguide 102 arranged between the first electrode 103A and the second electrode 103B. As a result, signal light transmitted through the rib optical waveguide 102 is absorbed due to free carrier absorption of the electric current flowing through the rib optical waveguide 102 and intensity of the signal light is thereby attenuated. That is, the amount of optical attenuation per unit length of the VOA 100 is dependent on the electric current per unit length.
Patent Literature 1: Japanese Laid-open Patent Publication No. 2000-275589
Patent Literature 2: Japanese Laid-open Patent Publication No. 2003-233048
Patent Literature 3: U.S. Patent Application Publication No. 2003/0147575
Patent Literature 4: Japanese Laid-open Patent Publication No. 2006-039569
Patent Literature 5: U.S. Patent Application Publication No. 2018/0059327

A voltage is uniformly applied in the longitudinal direction of the rib optical waveguide 102 in the VOA 100 upon application of voltage, and the electric current and amount of optical attenuation per unit length are thus also uniform. That is, the electric current and amount of optical attenuation per unit length of the rib optical waveguide 102 near the optical input portion 102B and the optical output portion 102C are also substantially uniform.

However, because the electric current and amount of optical attenuation per unit length of the rib optical waveguide 102 near the optical input portion 102B and the optical output portion 102C are substantially uniform although the intensity of signal light is high in the optical input portion 102B, optical absorption concentrates in a region near the optical input portion 102B. As a result, heat generation due to the optical absorption concentrated in the region near the optical input portion 102B is increased. The increase in the heat generation due to the optical absorption increases the temperature of the optical input portion 102B and accelerates the temporal change of the optical input portion 102B. As a result, the long-term reliability may be degraded due to the temporal change of the optical input portion 102B.

### SUMMARY

According to an aspect of an embodiment, an optical device includes a rib optical waveguide formed on a substrate, a P doped region formed in one of slab regions of the rib optical waveguide, an N doped region formed in the other one of the slab regions of the rib optical waveguide, a first electrode connected to the P doped region, a second electrode connected to the N doped region; and an optical absorption structure. The optical absorption structure implements optical absorption of signal light passing through the rib optical waveguide according to an electric current that flows between the first electrode and the second electrode, and makes, in the optical absorption, the signal light passing through an optical input portion of the rib optical waveguide lower in optical attenuation rate than the signal light passing through at least part of the rib optical waveguide, the part excluding the optical input portion.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a schematic plan view of an example of a VOA according to a first embodiment;

FIG. 2 is a schematic sectional view taken on a line A-A illustrated in FIG. 1;

FIG. 3 is a schematic plan view of an example of a VOA according to a second embodiment;

FIG. 4 is a schematic sectional view taken on a line A-A illustrated in FIG. 3;

FIG. 5A is a schematic plan view of a VOA that is a comparison target, the schematic plan view illustrating an example of evaluation conditions for the VOA;

FIG. 5B is a schematic plan view of the VOA according to the second embodiment, the schematic plan view illustrating an example of evaluation conditions for the VOA;

FIG. 6 is a diagram illustrating an example of distributions of optical absorption in the VOA that is the comparison target and the VOA according to the second embodiment;

FIG. 7 is a schematic plan view of an example of a VOA according to a third embodiment;

FIG. 8A is a schematic sectional view taken on a line A-A illustrated in FIG. 7;

FIG. 8B is a schematic sectional view taken on a line B-B illustrated in FIG. 7;

FIG. 9 is a schematic plan view of an example of a VOA according to a fourth embodiment;

FIG. 10A is a schematic sectional view taken on a line A-A illustrated in FIG. 9;

FIG. 10B is a schematic sectional view taken on a line B-B illustrated in FIG. 9;

FIG. 11 is a schematic plan view of an example of a VOA according to a fifth embodiment;

FIG. 12A is a schematic sectional view taken on a line A-A illustrated in FIG. 11;

FIG. 12B is a schematic sectional view taken on a line B-B illustrated in FIG. 11;

FIG. 13 is a schematic plan view of an example of a VOA according to a sixth embodiment;

FIG. 14A is a schematic sectional view taken on a line A-A illustrated in FIG. 13;

FIG. 14B is a schematic sectional view taken on a line B-B illustrated in FIG. 13;

FIG. 15 is a schematic plan view of an example of a VOA according to a seventh embodiment;

FIG. 16A is a schematic sectional view taken on a line A-A illustrated in FIG. 15;

FIG. 16B is a schematic sectional view taken on a line B-B illustrated in FIG. 15;

FIG. 17 is a diagram illustrating an example of an optical communication device having, adopted therein, a VOA according to an embodiment;

FIG. 18 is a schematic plan view of an example of a VOA; and

FIG. 19 is a schematic sectional view taken on a line A-A illustrated in FIG. 18.

### DESCRIPTION OF EMBODIMENTS

Preferred embodiments of the present invention will be explained with reference to accompanying drawings. Techniques disclosed herein are not limited by these embodiments. The following embodiments may be combined with one another as appropriate so long as no contradiction is caused by the combination.

### (a) First Embodiment

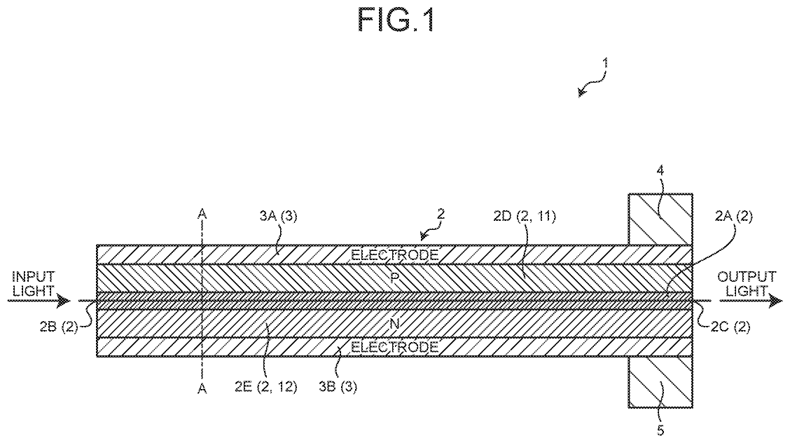

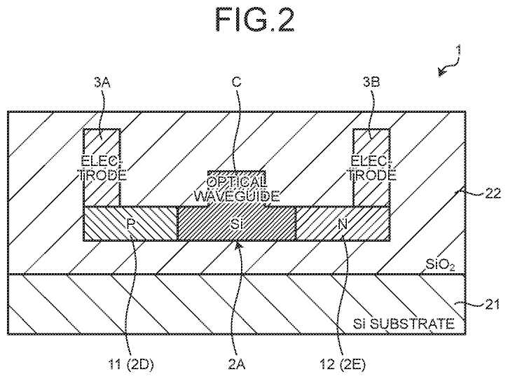

FIG. 1 is a schematic plan view of an example of a VOA 1 according to a first embodiment. FIG. 2 is a schematic sectional view taken on a line A-A illustrated in FIG. 1. The VOA 1 illustrated in FIG. 1 has a Si substrate 21, a rib optical waveguide 2 formed on the Si substrate 21, electrodes 3 connected onto slabs 2D and 2E on both sides of the rib optical waveguide 2, and a cladding layer 22 formed on the Si substrate 21 and surrounding the rib optical waveguide 2 and two electrodes 3.

The rib optical waveguide 2 is formed of, for example, Si. The rib optical waveguide 2 has a core C and the slabs 2D and 2E on both sides of the core C. The core C and part of the slabs 2D and 2E form an optical waveguide 2A. Furthermore, the rib optical waveguide 2 has an optical input portion 2B and an optical output portion 2C. The optical input portion 2B is an input stage of the rib optical waveguide 2, the input stage being where signal light is input to the optical waveguide 2A. The optical output portion 2C is an output stage of the rib optical waveguide 2, the output stage being where the signal light is output from the optical waveguide 2A. A P doped region 11 that has been P doped is formed in the slab 2D that is one of the slabs 2D and 2E, and an N doped region 12 that has been N doped is formed in the other slab 2E. The optical waveguide 2A is an undoped region. The rib optical waveguide 2 has, for example, a PIN diode structure including the P doped region 11, the optical waveguide 2A, and the N doped region 12.

The electrodes 3 include a first electrode 3A electrically connected to the P doped region 11 and a second electrode 3B electrically connected to the N doped region 12. The first electrode 3A is a signal electrode connected to a feeding pad 4 for application of voltage. The first electrode 3A is made of a material having electric resistance, for example, a metal, such as aluminum, or a semiconductor material, such as Si. The second electrode 3B is a ground electrode connected to a ground pad 5. The second electrode 3B is also made of a material having electric resistance, for example, a metal, such as aluminum, or a semiconductor material, such as Si or Ge.

The cladding layer 22 is formed of, for example, SiO₂. The feeding pad 4 is a first electrode pad connected to the first electrode 3A and arranged near the optical output portion 2C of the rib optical waveguide 2. The ground pad 5 is a second electrode pad connected to the second electrode 3B and arranged near the optical output portion 2C of the rib optical waveguide 2.

The first electrode 3A near the optical output portion 2C is smaller in width than the feeding pad 4 (the width in the vertical direction in the figure) and the second electrode 3B near the optical output portion 2C is smaller in width (the width in the vertical direction in the figure) than the ground pad 5.

The VOA 1 has an optical absorption structure that optically absorbs signal light passing through the rib optical waveguide 2 according to the electric current flowing between the first electrode 3A and the second electrode 3B. The optical absorption structure makes the electric current flowing between the first electrode 3A and the second electrode 3B in the optical input portion 2B smaller than the electric current in the optical output portion 2C. The optical absorption structure also makes the optical attenuation rate of signal light passing through the optical input portion 2B of the rib optical waveguide 2 smaller than the optical attenuation rate of signal light passing through the optical output portion 2C of the rib optical waveguide 2. For illustration purpose, the optical absorption structure is a structure that makes the optical attenuation rate of signal light passing through the optical input portion 2B smaller than the optical attenuation rate of signal light passing through the optical output portion 2C, but without being limited to the optical output portion 2C, this structure may be modified as appropriate, and for example, the optical attenuation rate of the signal light passing through the optical input portion 2B may be made smaller than that of at least any part of the optical waveguide, that any part excluding the optical input portion 2B.

Furthermore, the optical absorption structure has: the feeding pad 4 connected to the first electrode 3A and arranged near the optical output portion 2C of the rib optical waveguide 2; and the ground pad 5 connected to the second electrode 3B and arranged near the optical output portion 2C of the rib optical waveguide 2. The optical absorption structure also has the first electrode 3A smaller in width than the feeding pad 4 and the second electrode 3B smaller in width than the ground pad 5.

Operation of the VOA 1 according to the first embodiment will be described next. In a case where a positive voltage is applied to the feeding pad 4 in the VOA 1, an electric current will flow from the first electrode 3A to the second electrode 3B via the PIN structure (the P doped region 11, the optical waveguide 2A, and the N doped region 12) of the rib optical waveguide 2. As a result, a voltage drop is generated from the optical output portion 2C to the optical input portion 2B due to the electric current flowing through the first electrode 3A and the second electrode 3B and electric resistance of the first electrode 3A and the second electrode 3B.

Voltage near the optical input portion 2B decreases with distance from the feeding pad 4 and the electric current per unit length near the optical input portion 2B thus also decreases. That is, the electric current per unit length decreases near the optical input portion 2B distant from the feeding pad 4 and the amount of optical attenuation per unit length thus also decreases. As a result, the amount of optical attenuation per unit length, that is, optical absorption is decreased in the optical input portion 2B and concentration of heat generation in the optical input portion 2B due to optical absorption as conventionally observed is able to be avoided.

The arrangement of the feeding pad 4 and the ground pad 5 near the optical output portion 2C in the VOA 1 according to the first embodiment causes a voltage drop to be generated from the optical output portion 2C to the optical input portion 2B in a case where a voltage is applied to the feeding pad 4. That is, decreasing the electric current per unit length flowing through the optical input portion 2B makes the optical absorption in the optical input portion 2B less than the optical absorption in the optical output portion 2C. As a result, concentration of heat generation in the optical input portion 2B due to optical absorption as conventionally observed is able to be avoided by the decrease in the electric current per unit length flowing through the optical input portion 2B and the reduction of optical absorption in the optical input portion 2B. The long-term reliability is thereby improved.

Furthermore, in the VOA 1, the width of the first electrode 3A is smaller than the width of the feeding pad 4 and the width of the second electrode 3B is smaller than the width of the ground pad 5. In a case where a voltage is applied to the feeding pad 4, a voltage drop from the optical output portion 2C to the optical input portion 2B is generated. That is, decreasing the electric current per unit length flowing through the optical input portion 2B makes the optical absorption in the optical input portion 2B less than the optical absorption in the optical output portion 2C. As a result, concentration of heat generation in the optical input portion 2B due to optical absorption as conventionally observed is able to be avoided by the decrease in the electric current per unit length flowing through the optical input portion 2B and the reduction of optical absorption in the optical input portion 2B.

The above described example of the VOA 1 has both a first structure in which the feeding pad 4 and the ground pad 5 are arranged near the optical output portion 2C and a second structure in which the width of the first electrode 3A is smaller than the width of the feeding pad 4 and the width of the second electrode 3B is smaller than the width of the ground pad 5. However, even in a case where any one of the first structure or second structure is adopted, the electric current per unit length flowing through the optical input portion 2B is able to be decreased and the optical absorption in the optical input portion 2B is thus able to be reduced. Furthermore, FIG. 1 illustrates a structure having ends of the feeding pad 4 and the ground pad 5 aligned with the optical output portion 2C, but without being limited to this structure, as long as the feeding pad 4 and the ground pad 5 are arranged near the optical output portion 2C, the electric current per unit length flowing through the optical input portion 2B is able to be decreased and the optical absorption in the optical input portion 2B is thus able to be reduced. For example, the above described effects are achieved as long as a feeding pad 34 and the ground pad 5 are positioned nearer to the optical output portion 2C than the center of the VOA1 is, and desirably, the feeding pad 34 and the ground pad 5 are positioned nearer to the optical output portion 2C than the midpoint between the center of the VOA 1 and the optical input portion 2B is.

Decrease in the electric resistance with increase in the doping concentration of the P doped region 11 and the N doped region 12 enables reduction in power consumption of the VOA 1 according to the first embodiment. That is, the flowing electric current increases with the increase in the doping concentration and the absorption of light is thus increased. However, the optical loss increases even in a state where no electric current is flowing. A second embodiment that is an embodiment for addressing this issue will be described below.

### (b) Second Embodiment

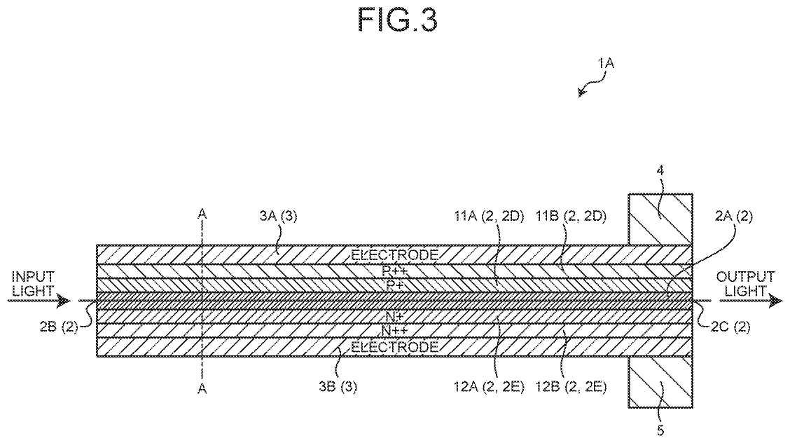

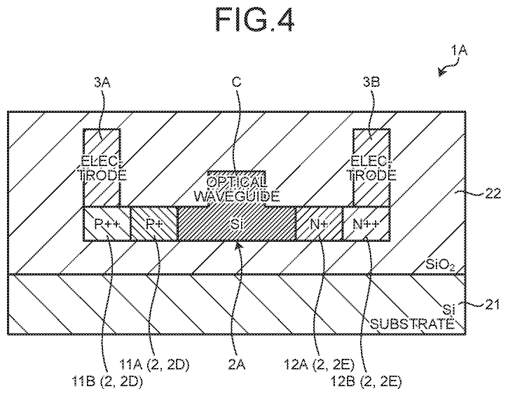

FIG. 3 is a schematic plan view of an example of a VOA 1A according to the second embodiment. FIG. 4 is a schematic sectional view taken on a line A-A illustrated in FIG. 3. By assignment of the same reference signs to components that are the same as those of the VOA 1 according to the first embodiment, description of the same components and operation thereof will be omitted. The VOA 1A according to the second embodiment is different from the VOA 1 according to the first embodiment in that the VOA 1A has regions provided in each of slabs 2D and 2E thereof, the regions having doping concentrations different from each other. In the slab 2D that is one of the slabs 2D and 2E, a P+ doped region 11A is formed near a core C and a P++ doped region 11B is formed near a first electrode 3A. Furthermore, in the other slab 2E, an N+ doped region 12A is formed near the core C and an N++ doped region 12B is formed near a second electrode 3B.

The P++ doped region 11B is a region having a higher doping concentration than the P+ doped region 11A. Because the P++ doped region 11B is arranged in the slab 2D near the first electrode 3A, the electric resistance is able to be decreased and the power consumption is thus able to be reduced. Furthermore, because the P+ doped region 11A is arranged in the slab 2D near the core C, increase in the optical loss in a state where no electric current is flowing is able to be avoided.

The N++ doped region 12B is a region having a higher doping concentration than the N+ doped region 12A. Because the N++ doped region 12B is arranged in the slab 2E near the second electrode 3B, the electric resistance is able to be decreased and the power consumption is thus able to be reduced. Furthermore, because the N+ doped region 12A is arranged in the slab 2E near the core C, increase in the optical loss in the state where no electric current is flowing is able to be avoided.

The VOA 1A according to the second embodiment has the P++ doped region 11B arranged in the slab 2D near the first electrode 3A and the N++ doped region 12B arranged in the slab 2E near the second electrode 3B, and thus enables decrease in the electric resistance and reduction in the power consumption. Furthermore, because the P+ doped region 11A and the N+ doped region 12A are arranged in the slabs 2D and 2E near the core C, increase in the optical loss in the state where no electric current is flowing is able to be avoided.

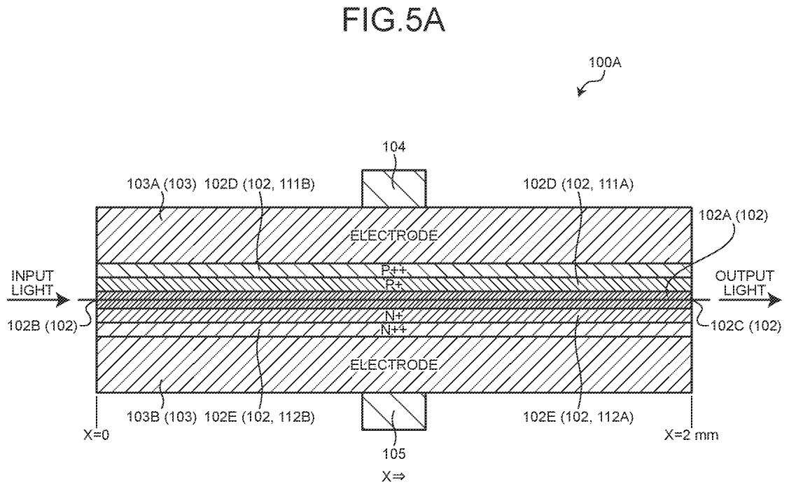

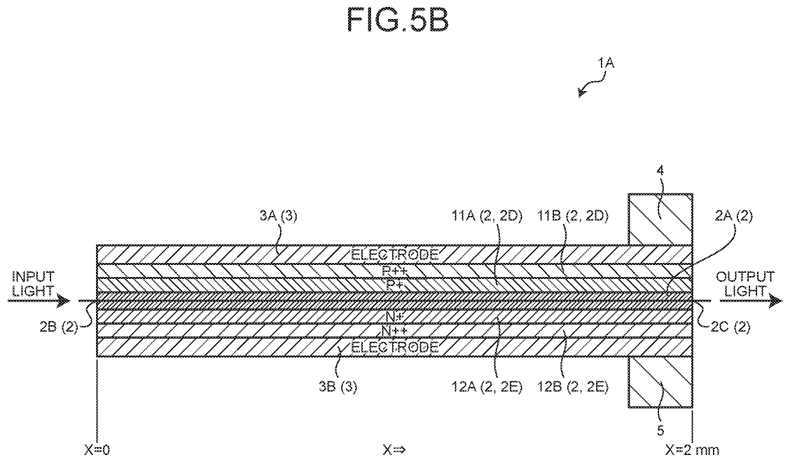

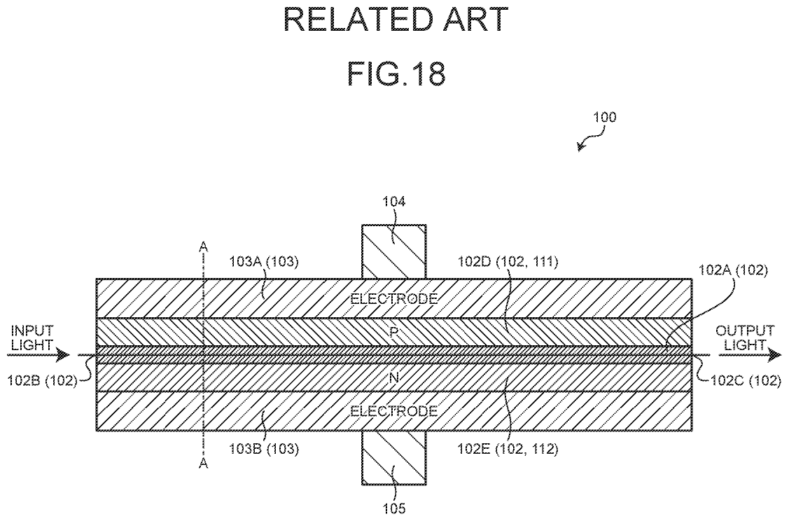

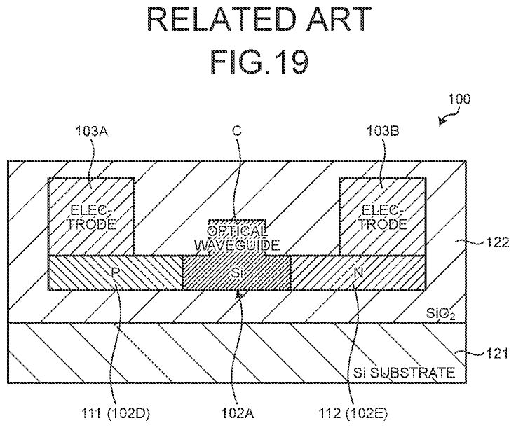

FIG. 5A is a schematic plan view of a VOA 100A that is a comparison target, the schematic plan view illustrating an example of evaluation conditions. By assignment of the same reference signs to components that are the same as those of the VOA 100 illustrated in FIG. 18, description of the same components and operation thereof will be omitted. The VOA 100A illustrated in FIG. 5A is different from the VOA 100 illustrated in FIG. 18 in that the VOA 100A has a P doped region 111 divided into regions having concentrations different from each other and an N doped region 112 divided into regions having concentrations different from each other.

In a slab 102D illustrated in FIG. 5A, the slab 102D being one of two slabs, a P+ doped region 111A is formed near a core C and a P++ doped region 111B is formed near a first electrode 103A. Furthermore, in a slab 102E that is the other one of the two slabs, an N+ doped region 112A is formed near the core C and an N++ doped region 112B is formed near a second electrode 103B. A position along a longitudinal direction of a rib optical waveguide 102 of the VOA 100A is represented herein by X mm. The VOA 100A is assumed herein to have an optical input portion 102B at a position, X=0 mm, and an optical output portion 102C at a position, X=2 mm.

FIG. 5B is a schematic plan view of the VOA 1A according to the second embodiment, the schematic plan view illustrating an example of evaluation conditions. A position along a longitudinal direction of a rib optical waveguide 2 of the VOA 1A is represented herein by X mm. The VOA 1A has an optical input portion 2B at a position, X=0 mm, and an optical output portion 2C at a position, X=2 mm.

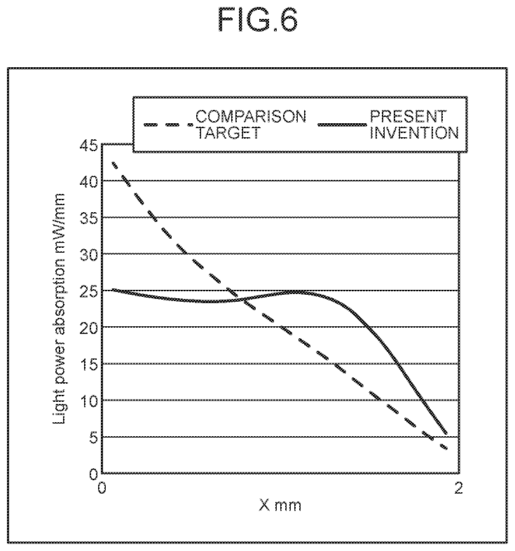

FIG. 6 is a diagram illustrating an example of distributions of optical absorption in the VOA 100A that is the comparison target and the VOA 1A according to the second embodiment. In the VOA 100A that is the comparison target and illustrated in FIG. 5A, a feeding pad 104 is positioned near the center of the VOA 100A, and the first electrode 103A has the same width as the feeding pad 104. Furthermore, in the VOA 100A that is the comparison target, a ground pad 105 is positioned near the center of the VOA 100A, and the second electrode 103B has the same width as the ground pad 105. As illustrated in FIG. 6, optical absorption per unit length at the position (X=2 mm) of the optical output portion 102C of the VOA 100A that is the comparison target is small, but optical absorption per unit length at the position (X=0 mm) of the optical input portion 102B is as large as 42 mW/mm.

By contrast, in the VOA 1A according to the second embodiment illustrated in FIG. 5B, a feeding pad 4 is positioned near the optical output portion 2C and the first electrode 3A has a smaller width than the feeding pad 4. In the VOA 1A, a ground pad 5 is positioned near the optical output portion 2C and the second electrode 3B has a smaller width than the ground pad 5. As illustrated in FIG. 6, optical absorption per unit length at the position (X=2 mm) of the optical output portion 2C of the VOA 1A according to the second embodiment is small, but optical absorption per unit length at the position (X=0 mm) of the optical input portion 2B is as small as 25 mW/mm. That is, as compared with the VOA 100A that is the comparison target, the VOA 1A according to the second embodiment enables significant reduction of concentration of optical absorption in the optical input portion 2B and thus reduction of heat generation in the optical input portion 2B.

The VOA 1 according to the first embodiment is configured such that the first electrode 3A has a linear structure having the same width at the optical input portion 2B and the optical output portion 2C and the second electrode 3B also has a linear structure having the same width at the optical input portion 2B and the optical output portion 2C. However, a third embodiment that is an embodiment not limited to this configuration will be described below. By assignment of the same reference signs to components that are the same as those of the VOA 1 according to the first embodiment, description of the same components and operation thereof will be omitted.

### (c) Third Embodiment

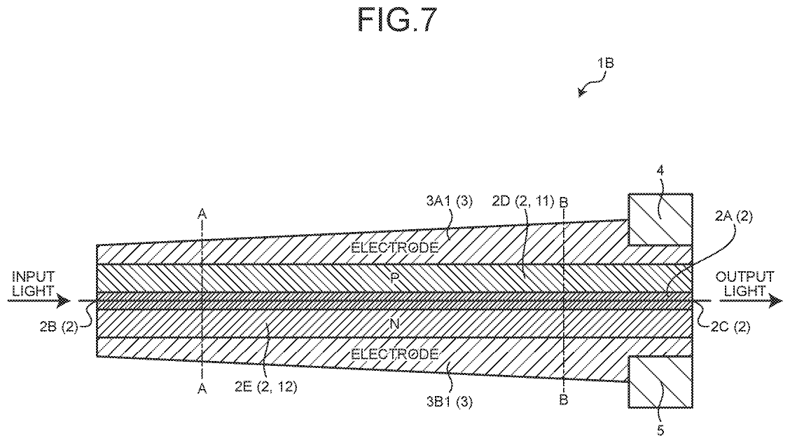

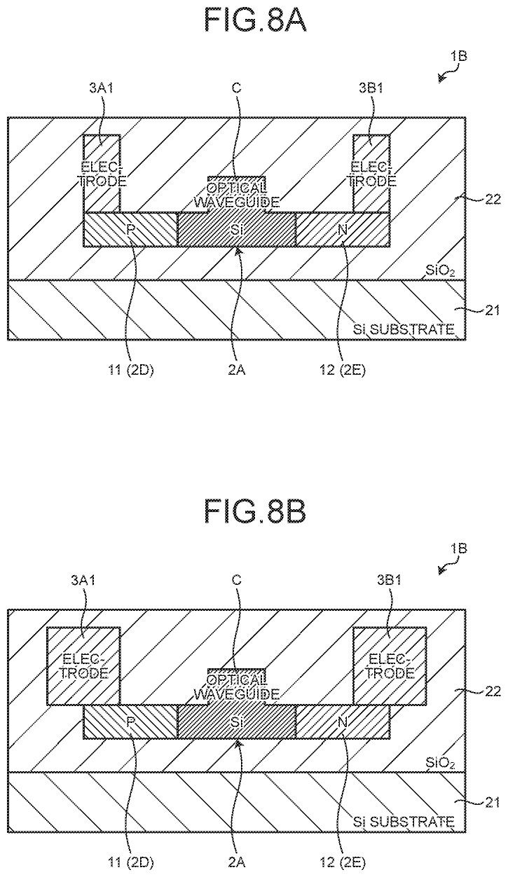

FIG. 7 is a schematic plan view of an example of a VOA 1B according to the third embodiment. FIG. 8A is a schematic sectional view taken on a line A-A illustrated in FIG. 7. FIG. 8B is a schematic sectional view taken on a line B-B illustrated in FIG. 7. The VOA 1B according to the third embodiment is different from the VOA 1 according to the first embodiment in that the VOA 1B is structured to have electrodes 3 that gradually decrease in width toward an optical input portion 2B thereof from an optical output portion 2C thereof. A first electrode 3A1 has a tapered structure that gradually narrows from the optical output portion 2C toward the optical input portion 2B. The first electrode 3A1 near the optical input portion 2B is smaller in width than the first electrode 3A1 near the optical output portion 2C. A second electrode 3B1 has a tapered structure that gradually narrows from the optical output portion 2C toward the optical input portion 2B. The second electrode 3B1 near the optical input portion 2B is smaller in width than the second electrode 3B1 near the optical output portion 2C.

Furthermore, the first electrode 3A1 near the optical output portion 2C is smaller in width than a feeding pad 4 and the second electrode 3B1 near the optical output portion 2C is smaller in width than a ground pad 5.

An optical absorption structure in the VOA 1B has the first electrode 3A1 that gradually decreases in electrode width toward the optical input portion 2B from the optical output portion 2C and the second electrode 3B1 that gradually decreases in electrode width toward the optical input portion 2B from the optical output portion 2C. The optical absorption structure makes the electric current flowing between the first electrode 3A1 and the second electrode 3B1 in the optical input portion 2B smaller than the electric current in the optical output portion 2C. The optical absorption structure also makes the optical attenuation rate of signal light passing through the optical input portion 2B smaller than the optical attenuation rate of signal light passing through the optical output portion 2C. For illustration purpose, the optical absorption structure is a structure that makes the optical attenuation rate of signal light passing through the optical input portion 2B smaller than the optical attenuation rate of signal light passing through the optical output portion 2C, but without being limited to the optical output portion 2C, this structure may be modified as appropriate, and for example, the optical attenuation rate of the signal light passing through the optical input portion 2B may be made smaller than that of at least any part of the optical waveguide, that any part excluding the optical input portion 2B.

Operation of the VOA 1B according to the third embodiment will be described next. In a case where a positive voltage is applied to the feeding pad 4 in the VOA 1B, an electric current flows to the second electrode 3B1 via a PIN structure (a P doped region 11, an optical waveguide 2A, and an N doped region 12) of a rib optical waveguide 2, from the first electrode 3A1. As a result, a voltage drop is generated from the optical output portion 2C to the optical input portion 2B due to the electric current flowing through the first electrode 3A1 and the second electrode 3B1 and electric resistance of the first electrode 3A1 and the second electrode 3B1.

Voltage near the optical input portion 2B decreases with distance from the feeding pad 4 and the electric current per unit length near the optical input portion 2B thus also decreases. Therefore, the amount of optical attenuation per unit length in the optical input portion 2B decreases. As a result, the amount of optical attenuation per unit length, that is, optical absorption decreases in the optical input portion 2B and concentration of heat generation in the optical input portion 2B due to optical absorption as conventionally observed is able to be avoided.

The VOA 1B according to the third embodiment is structured such that the first electrode 3A1 and the second electrode 3B1 gradually narrow toward the optical input portion 2B from the optical output portion 2C and thus enables generation of a voltage drop from the optical output portion 2C to the optical input portion 2B due to these electrodes. That is, decreasing the electric current per unit length flowing through the optical input portion 2B makes the optical absorption in the optical input portion 2B smaller than the optical absorption in the optical output portion 2C. As a result, concentration of heat generation in the optical input portion 2B due to optical absorption as conventionally observed is able to be avoided by the decrease in the electric current per unit length flowing through the optical input portion 2B and the reduction of optical absorption in the optical input portion 2B. The long-term reliability is thereby improved.

The above described example of the VOA 1B has both a first structure having the feeding pad 4 and the ground pad 5 arranged near the optical output portion 2C and a second structure having the first electrode 3A1 and the second electrode 3B1 gradually decreasing in width from the optical output portion 2C toward the optical input portion 2B. However, even in a case where the third structure is adopted without the first structure, the electric current per unit length flowing through the optical input portion 2B is able to be decreased and the optical absorption in the optical input portion 2B is thus able to be reduced.

Decrease in electric resistance with increase in doping concentrations of the P doped region 11 and the N doped region 12 enables reduction in power consumption of the VOA 1B according to the third embodiment. That is, the flowing electric current increases with the increase in doping concentration and the absorption of light thus increases. However, the optical loss increases even in a state where no electric current is flowing. A fourth embodiment that is an embodiment for addressing this issue will be described below.

### (d) Fourth Embodiment

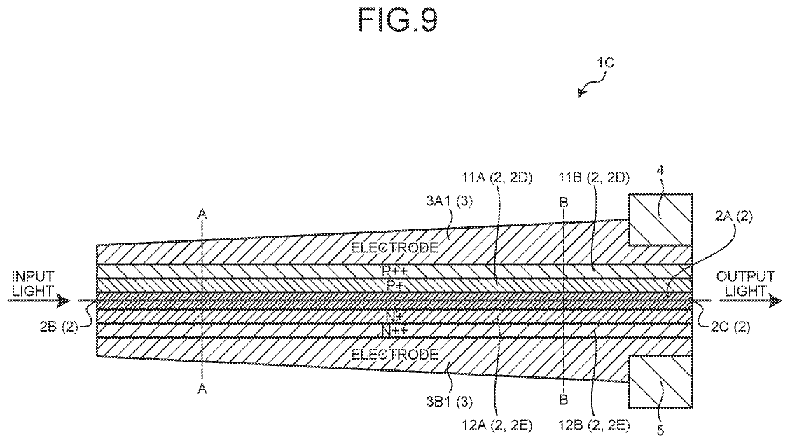

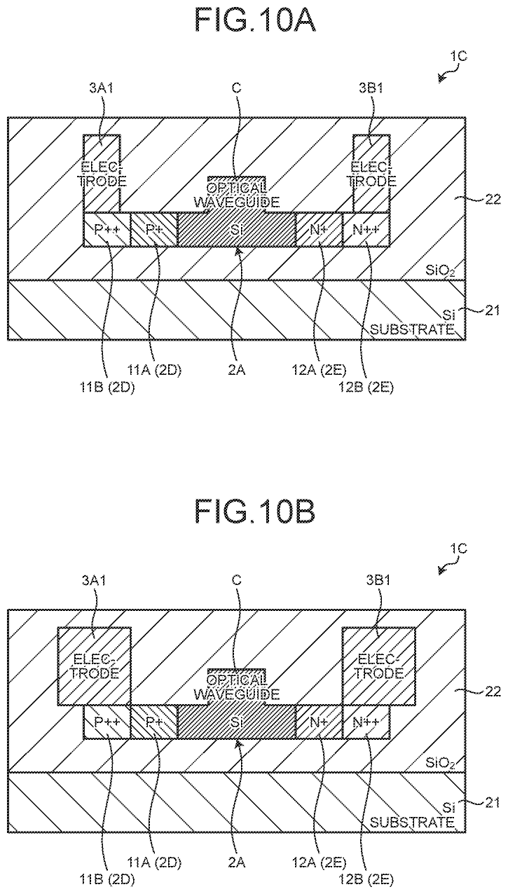

FIG. 9 is a schematic plan view of an example of a VOA 1C according to the fourth embodiment. FIG. 10A is a schematic sectional view taken on a line A-A illustrated in FIG. 9. FIG. 10B is a schematic sectional view taken on a line B-B illustrated in FIG. 9. By assignment of the same reference signs to components that are the same as those of the VOA 1B according to the third embodiment, description of the same components and operation thereof will be omitted. The VOA 1C according to the fourth embodiment is different from the VOA 1B according to the third embodiment in that regions having doping concentrations different from each other have been provided in each of slabs 2D and 2E thereof. In the slab 2D that is one of the slabs 2D and 2E, a P+ doped region 11A is formed near a core C and a P++ doped region 11B is formed near a first electrode 3A1. Furthermore, in the other slab 2E, an N+ doped region 12A is formed near the core C and an N++ doped region 12B is formed near a second electrode 3B1.

The P++ doped region 11B is a region having a higher doping concentration than the P+ doped region 11A. Because the P++ doped region 11B is arranged in the slab 2D near the first electrode 3A1, the electric resistance is able to be decreased and the power consumption is thus able to be reduced. Furthermore, because the P+ doped region 11A is arranged in the slab 2D near the core C, increase in the optical loss in a state where no electric current is flowing is able to be avoided.

The N++ doped region 12B is a region having a higher doping concentration than the N+ doped region 12A. Because the N++ doped region 12B is arranged in the slab 2E near the second electrode 3B1, the electric resistance is able to be decreased and the power consumption is thus able to be reduced. Furthermore, because the N+ doped region 12A is arranged in the slab 2E near the core C, increase in the optical loss in a state where no electric current is flowing is able to be avoided.

The VOA 1C according to the fourth embodiment has the P++ doped region 11B arranged in the slab 2D near the first electrode 3A1 and the N++ doped region 12B arranged in the slab 2E near the second electrode 3B1, and thus enables decrease in the electric resistance and reduction in the power consumption. Furthermore, because the P+ doped region 11A and the N+ doped region 12A are arranged in the slab 2E near the core C, increase in the optical loss in the state where no electric current is flowing is able to be avoided.

In the above described example of the VOA 1 (1A) according to the first or second embodiment, a voltage dop due to the electrodes 3 is generated because of the structure having the first electrode 3A and the second electrode 3B gradually increasing in width from the optical output portion 2C toward the optical input portion 2B. However, in an embodiment described below as a fifth embodiment, a voltage drop is able to be generated without the structure having the first electrode 3A and the second electrode 3B that change in width.

### (e) Fifth Embodiment

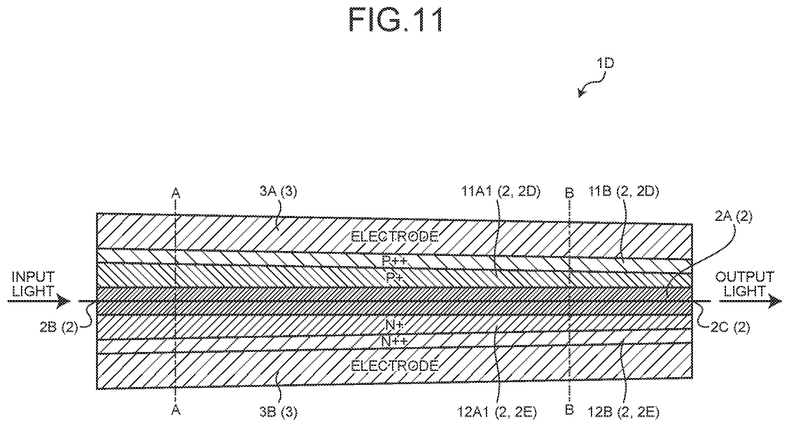

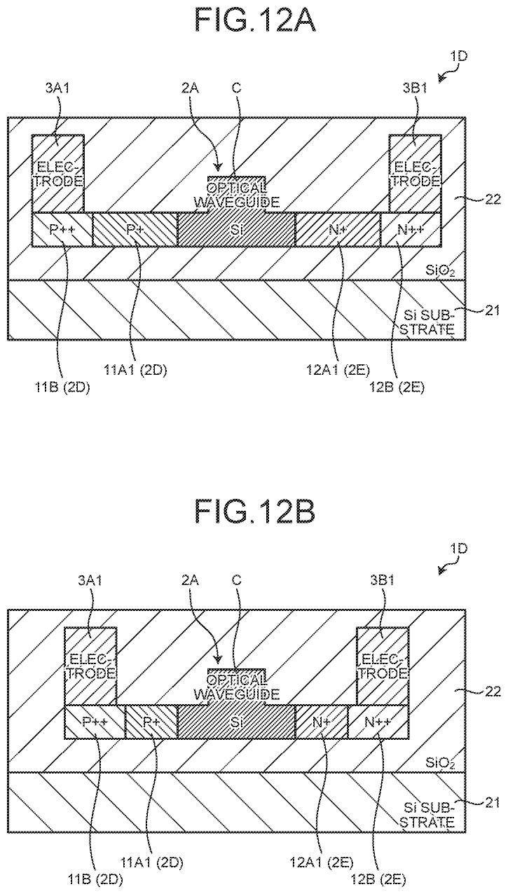

FIG. 11 is a schematic plan view of an example of a VOA 1D of the fifth embodiment. FIG. 12A is a schematic sectional view taken on a line A-A illustrated in FIG. 11. FIG. 12B is a schematic sectional view taken on a line B-B illustrated in FIG. 11. By assignment of the same reference signs to components that are the same as those of the VOA 1A according to the second embodiment, description of the same components and operation thereof will be omitted. The VOA 1D according to the fifth embodiment is different from the VOA 1A according to the second embodiment in that the VOA 1D has, instead of the structure of the first electrode 3A and the second electrode 3B, a structure including a P+ doped region 11A1 and an N+ doped region 12A1 in slabs 2D and 2E of a rib optical waveguide 2 thereof, the P+ doped region 11A1 and the N+ doped region 12A1 gradually increasing in width toward an optical input portion 2B thereof from an optical output portion 2C thereof.

The P+ doped region 11A1 has a tapered structure that gradually widens toward the optical input portion 2B from the optical output portion 2C. The P+ doped region 11A1 near the optical input portion 2B has a larger width than the P+ doped region 11A1 near the optical output portion 2C. The N+ doped region 12A1 has a tapered structure that gradually widens toward the optical input portion 2B from the optical output portion 2C. The N+ doped region 12A1 near the optical input portion 2B is structured to be larger in width than the N+ doped region 12A1 near the optical output portion 2C. That is, making the P+ doped region 11A1 and N+ doped region 12A1 larger in width near the optical input portion 2B enables generation of a voltage drop from the optical output portion 2C to the optical input portion 2B by increase in the electric resistance of the P+ doped region 11A1 and N+ doped region 12A1. The feeding pad 4 may be modified as appropriate to be arranged at any position on the first electrode 3A, and the ground pad 5 may also be modified as appropriate to be arranged at any position on the second electrode 3B.

That is, an optical absorption structure in the VOA 1D has the P+ doped region 11A1 that gradually increases in width toward the optical input portion 2B from the optical output portion 2C and the N+ doped region 12A1 that gradually increases in width toward the optical input portion 2B from the optical output portion 2C. The optical absorption structure makes the electric current flowing between the first electrode 3A and the second electrode 3B in the optical input portion 2B smaller than the electric current in the optical output portion 2C. The optical absorption structure also makes the optical attenuation rate of signal light passing through the optical input portion 2B smaller than the optical attenuation rate of signal light passing through the optical output portion 2C. For illustration purpose, the optical absorption structure is a structure that makes the optical attenuation rate of signal light passing through the optical input portion 2B smaller than the optical attenuation rate of signal light passing through the optical output portion 2C, but without being limited to the optical output portion 2C, this structure may be modified as appropriate, and for example, the optical attenuation rate of the signal light passing through the optical input portion 2B may be made smaller than that of at least any part of the optical waveguide, that any part excluding the optical input portion 2B.

Operation of the VOA 1D according to the fifth embodiment will be described next. In the VOA 1D, electric current flows from the first electrode 3A to the second electrode 3B via a PIN structure (a P++ doped region 11B, the P+ doped region 11A1, an optical waveguide 2A, the N+ doped region 12A1, and an N++ doped region 12B) of the rib optical waveguide 2. As a result, a voltage drop is generated from the optical output portion 2C to the optical input portion 2B due to the electric current flowing through the first electrode 3A and the second electrode 3B and the electric resistance of the P+ doped region 11A1 and the N+ doped region 12A1.

The drop in voltage near the optical input portion 2B in the P+ doped region 11A1 and N+ doped region 12A1 decreases the electric current per unit length near the optical input portion 2B. That is, because the electric current per unit length near the optical input portion 2B decreases, the amount of optical attenuation per unit length also decreases. As a result, the amount of optical attenuation per unit length, that is, optical absorption is reduced in the optical input portion 2B and concentration of heat generation in the optical input portion 2B due to optical absorption as conventionally observed is able to be avoided.

The VOA 1D according to the fifth embodiment is structured such that the P+ doped region 11A1 and N+ doped region 12A1 gradually widen toward the optical input portion 2B from the optical output portion 2C and thus generates a voltage drop from the optical output portion 2C to the optical input portion 2B due to the doped layers. That is, decreasing the electric current per unit length flowing through the optical input portion 2B makes the optical absorption in the optical input portion 2B smaller than the optical absorption in the optical output portion 2C. As a result, concentration of heat generation in the optical input portion 2B due to optical absorption as conventionally observed is able to be avoided by the decrease in electric current per unit length flowing through the optical input portion 2B and the reduction in optical absorption in the optical input portion 2B. The long-term reliability is thereby improved.

In the above described example of the VOA 1D according to the fifth embodiment, the P+ doped region 11A1 and P++ doped region 11B are formed in the slab 2D that is one of the slabs 2D and 2E, and the N+ doped region 12A1 and the N++ doped region 12B are formed in the other slab 2E. However, a voltage drop due to doped layers may be generated by a structure having a P doped region 11 formed in the slab 2D that is one of the slabs 2D and 2E and an N doped region 12 formed in the other slab 2E, the P doped region 11 and the N doped region 12 gradually widening toward the optical input portion 2B from the optical output portion 2C.

In the above described example of the VOA 1 (1A) according to the first or second embodiment, the first electrode 3A and the second electrode 3B gradually increase in width from the optical input portion 2B to the optical output portion 2C and a voltage drop due to the electrodes 3 is thus achieved. However, an embodiment described below as a sixth embodiment enables reduction of optical absorption in an optical input portion 2B by change in the distribution of light in the optical waveguide 2A instead of the generation of the voltage drop due to the electrodes 3.

### (f) Sixth Embodiment

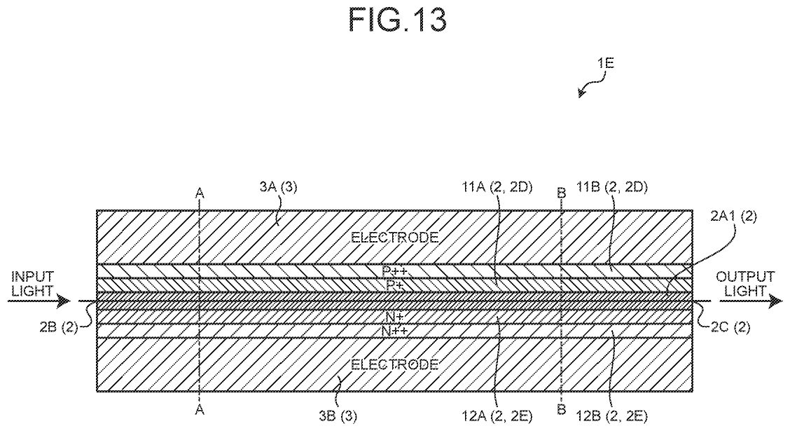

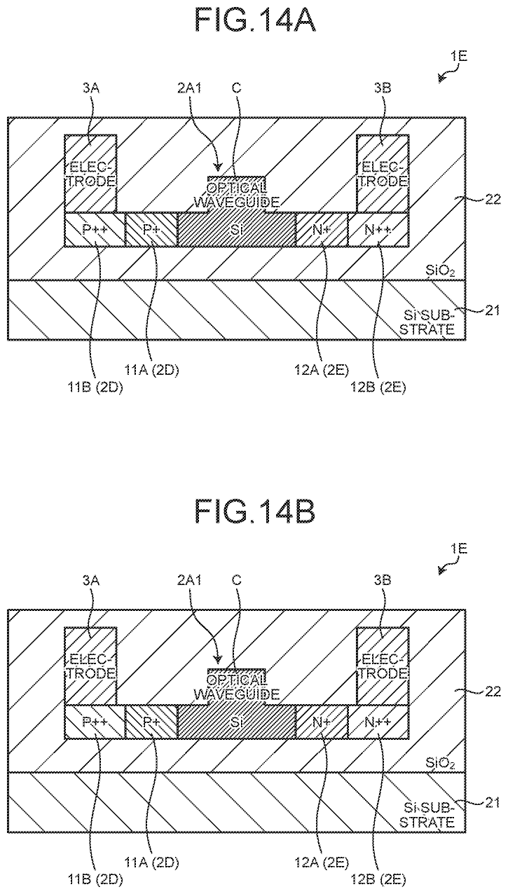

FIG. 13 is a schematic plan view of an example of a VOA 1E of the sixth embodiment. FIG. 14A is a schematic sectional view taken on a line A-A illustrated in FIG. 13. FIG. 14B is a schematic sectional view taken on a line B-B illustrated in FIG. 13. By assignment of the same reference signs to components that are the same as those according to the second embodiment, description of the same components and operation thereof will be omitted. A VOA 1E according to the sixth embodiment is different from the VOA 1A according to the second embodiment in that the VOA 1E is structured such that an optical waveguide 2A1 of a rib optical waveguide 2 thereof gradually widens toward an optical output portion 2C from an optical input portion 2B, instead of having the first electrode 3A and the second electrode 3B changed in width.

The optical waveguide 2A1 has a structure that gradually widens toward the optical output portion 2C from the optical input portion 2B. The optical waveguide 2A1 near the optical input portion 2B is narrower in width than the optical waveguide 2A1 near the optical output portion 2C. Optical confinement decreases in the optical input portion 2B where the optical waveguide 2A1 is narrow in width and optical absorption of signal light due to the electric current thus decreases. By contrast, optical confinement increases in the optical output portion 2C where the optical waveguide 2A1 is large in width and optical absorption of signal light due to the electric current thus increases. A feeding pad 4 may be arranged at any position on a first electrode 3A, a ground pad 5 may also be arranged at any position on a second electrode 3B, and their arrangement may be modified as appropriate.

That is, an optical absorption structure in the VOA 1E has the optical waveguide 2A1 that gradually decreases in waveguide width toward the optical input portion 2B from the optical output portion 2C. The optical absorption structure makes confinement of signal light passing through the optical input portion 2B larger than that through the optical output portion 2C and thereby makes the optical attenuation rate of signal light passing through the optical input portion 2B lower than the optical attenuation rate of signal light passing through the optical output portion 2C. For illustration purpose, the optical absorption structure is a structure that makes the optical attenuation rate of signal light passing through the optical input portion 2B smaller than the optical attenuation rate of signal light passing through the optical output portion 2C, but without being limited to the optical output portion 2C, this structure may be modified as appropriate, and for example, the optical attenuation rate of the signal light passing through the optical input portion 2B may be made smaller than that of at least any part of the optical waveguide, that any part excluding the optical input portion 2B.

Operation of the VOA 1E according to the sixth embodiment will be described next. In the VOA 1E, electric current flows from the first electrode 3A to the second electrode 3B via a PIN structure (a P++ doped region 11B, a P+ doped region 11A, the optical waveguide 2A1, an N+ doped region 12A, and an N++ doped region 12B) of the rib optical waveguide 2.

The optical waveguide 2A1 is narrow in width near the optical input portion 2B and the optical confinement is thus small and optical absorption of signal light due to the electric current is thus reduced. As a result, concentration of heat generation in the optical input portion 2B due to optical absorption as conventionally observed is able to be avoided.

The VOA 1E according to the sixth embodiment is structured such that the optical waveguide gradually increases in width toward the optical output portion 2C from the optical input portion 2B and optical confinement in the optical waveguide 2A1 at the optical input portion 2B is thus weakened and optical absorption of signal light due to the electric current is thus reduced. As a result, concentration of heat generation in the optical input portion 2B due to optical absorption as conventionally observed is able to be avoided by the reduction of optical confinement in the optical waveguide 2A1 at the optical input portion 2B and the reduction of optical absorption in the optical input portion 2B. The long-term reliability is thereby improved.

In the above described example of the VOA 1E according to the sixth embodiment, the P+ doped region 11A and P++ doped region 11B are formed in the slab 2D that is one of the slabs 2D and 2E, and the N+ doped region 12A and the N++ doped region 12B are formed in the other slab 2E. However, this example may be modified as appropriate, and a P doped region 11 may be formed in the one slab 2D and an N doped region 12 may be formed in the other slab 2E.

Furthermore, in an embodiment described below as a seventh embodiment, a voltage drop is able to be generated without the change in width of the first electrode 3A and the second electrode 3B.

### (g) Seventh Embodiment

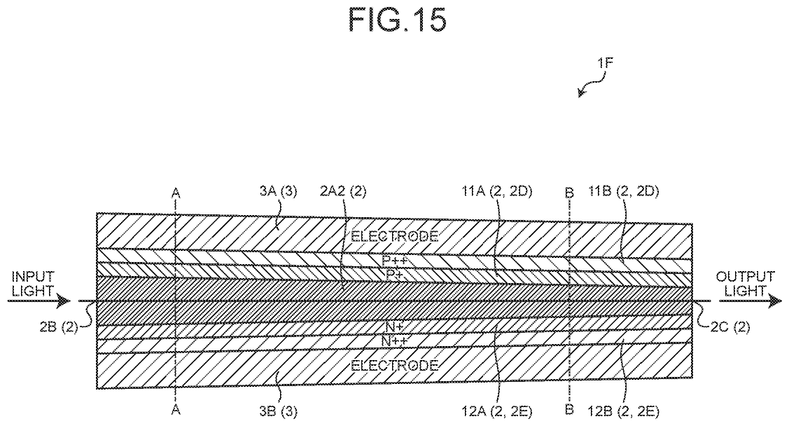

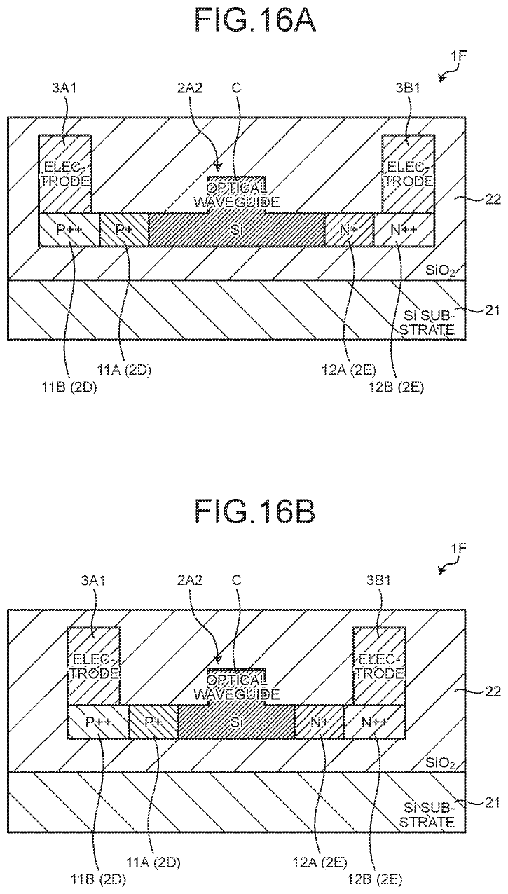

FIG. 15 is a schematic plan view of an example of a VOA 1F according to the seventh embodiment. FIG. 16A is a schematic sectional view taken on a line A-A illustrated in FIG. 15. FIG. 16B is a schematic sectional view taken on a line B-B illustrated in FIG. 15. By assignment of the same reference signs to components that are the same as those according to the second embodiment, description of the same components and operation thereof will be omitted. The VOA 1F according to the seventh embodiment is different from the VOA 1A according to the second embodiment in that an optical waveguide 2A2 of a rib optical waveguide 2 in the VOA 1F is made of undoped Si and structured to gradually increase in waveguide width toward an optical input portion 2B from an optical output portion 2C. The optical waveguide 2A2 is an undoped optical waveguide between a P+ doped region 11A and an N+ doped region 12A.

The optical waveguide 2A2 is structured to gradually narrow toward the optical input portion 2B from the optical output portion 2C. The optical waveguide 2A2 near the optical input portion 2B is narrower in width than the optical waveguide 2A2 near the optical output portion 2C. The electric resistance increases and the electric current flowing decreases with the increase in width of the undoped optical waveguide 2A2 and the dependency of the undoped width that reduces optical absorption of signal light passing is thus utilized. A feeding pad 4 may be arranged at any position on a first electrode 3A, a ground pad 5 may also be arranged at any position on a second electrode 3B, and their arrangement may be modified as appropriate.

That is, an optical absorption structure in the VOA 1F has the optical waveguide 2A2 that is an undoped portion that gradually increases in waveguide width toward the optical input portion 2B from the optical output portion 2C. The optical absorption structure makes the electric current flowing between the first electrode 3A and the second electrode 3B in the optical input portion 2B smaller than the electric current in the optical output portion 2C. The optical absorption structure also makes the optical attenuation rate of signal light passing through the optical input portion 2B smaller than the optical attenuation rate of signal light passing through the optical output portion 2C. For illustration purpose, the optical absorption structure is a structure that makes the optical attenuation rate of signal light passing through the optical input portion 2B smaller than the optical attenuation rate of signal light passing through the optical output portion 2C, but without being limited to the optical output portion 2C, this structure may be modified as appropriate, and for example, the optical attenuation rate of the signal light passing through the optical input portion 2B may be made smaller than that of at least any part of the optical waveguide, that any part excluding the optical input portion 2B.

Operation of the VOA 1F according to the seventh embodiment will be described next. In the VOA 1F, electric current flows from the first electrode 3A to the second electrode 3B via a PIN structure (a P++ doped region 11B, the P+ doped region 11A, the optical waveguide 2A2, the N+ doped region 12A, and an N++ doped region 12B) of the rib optical waveguide 2. As a result, a voltage drop is generated from the optical output portion 2C to the optical input portion 2B due to the electric current flowing through the first electrode 3A and the second electrode 3B and the electric resistance of the undoped optical waveguide 2A2.

The optical waveguide 2A2 in the optical input portion 2B is wide and thus high in electric resistance, and a voltage drop is thus generated and the electric current therein per unit length thus becomes small. Therefore, the amount of optical attenuation per unit length in the optical input portion 2B becomes small. As a result, the amount of optical attenuation per unit length becomes small in the optical input portion 2B and concentration of heat generation in the optical input portion 2B due to optical absorption as conventionally observed is able to be avoided.

The VOA 1F according to the seventh embodiment is structured such that the undoped optical waveguide 2A2 gradually increases in waveguide width toward the optical input portion 2B from the optical output portion 2C and thus achieves a voltage drop that is a gradual reduction of the electric current flowing between the electrodes 3 from the optical output portion 2C to the optical input portion 2B. As a result, concentration of heat generation in the optical input portion 2B due to optical absorption as conventionally observed is able to be avoided by the decrease in electric current per unit length flowing through the optical input portion 2B and the reduction in optical absorption in the optical input portion 2B. The long-term reliability is thereby improved.

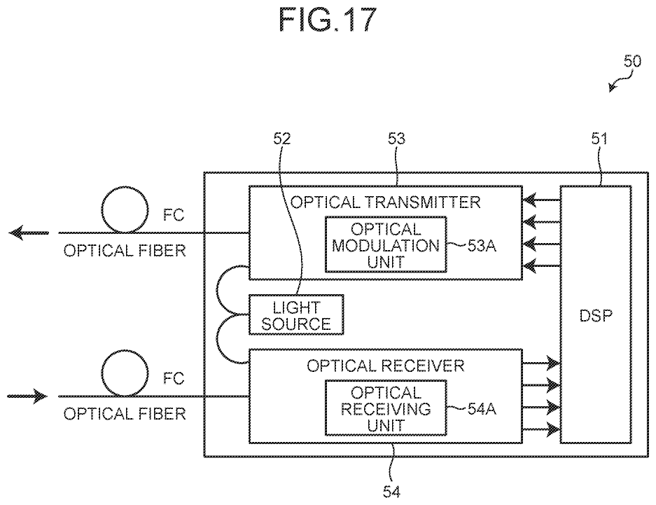

An optical communication device 50 having, adopted therein, the VOA 1 (1A to 1F) according to any one of the first to seventh embodiments will be described next. FIG. 17 is a diagram illustrating an example of the optical communication device 50 having, adopted therein, the VOA 1 according to any one of the embodiments. The optical communication device 50 illustrated in FIG. 17 is connected to an optical fiber FC at an output end thereof and an optical fiber FC at an input end thereof. The optical communication device 50 has a digital signal processor (DSP) 51, a light source 52, an optical transmitter 53, and an optical receiver 54. The DSP 51 is an electric component that executes digital signal processing. For example, the DSP 51 executes processing, such as coding, of transmitted data, generates an electric signal including the transmitted data, and outputs the electric signal generated, to the optical transmitter 53. Furthermore, the DSP 51 obtains an electric signal including received data from the optical receiver 54, executes processing, such as decoding, of the electric signal obtained, and obtains the received data.

The light source 52 includes, for example, a laser diode, generates light of a predetermined wavelength, and supplies the light to the optical transmitter 53 and the optical receiver 54. The optical transmitter 53 modulates the light supplied from the light source 52 using an electric signal output from the DSP 51 and outputs transmitted light obtained to the optical fiber FC. The optical transmitter 53 has an optical modulation unit 53A that generates, upon propagation of the light supplied from the light source 52 through a waveguide, the transmitted light by modulating the light using the electric signal input to an optical modulator.

The optical receiver 54 has an optical receiving unit 54A that receives an optical signal from the optical fiber FC and demodulates received light using light supplied from the light source 52. The optical receiver 54 converts the demodulated received light into an electric signal and outputs the electric signal that has been converted, to the DSP 51. The optical transmitter 53 and the optical receiver 54 each has the VOA 1 built therein, the VOA 1 being a substrate type optical waveguide element that serves as a waveguide for light.

For illustration purpose, the above described example of the optical communication device 50 has, built therein, the optical transmitter 53 and the optical receiver 54, but the optical communication device 50 may have any one of the optical transmitter 53 and the optical receiver 54, built therein. For example, the VOA 1 (1A to 1F) may be applied to an optical communication device 50 having a built-in optical transmitter 53 or an optical communication device 50 having a built-in optical receiver 54 and the example may be modified as appropriate.

In the embodiments, the rib optical waveguide 2 may be a planar lightwave circuit (PLC) having a core and a cladding both made of SiO₂, an InP waveguide, or a GaAs waveguide. The rib optical waveguide 2 may have a core made of Si or Si₃N₄, a lower cladding made of SiO₂, and an upper cladding made of SiO₂ or air, for example.

The components of each unit illustrated in the drawings may be not configured physically as illustrated in the drawings. That is, specific forms of distribution and integration of each unit are not limited to those illustrated in the drawings, and all or part of each unit may be configured to be distributed or integrated functionally or physically in any units, according to various loads and/or use situations, for example.

All or any part of various processing functions implemented by each device may be executed on a central processing unit (CPU) (or a microcomputer, such as a micro processing unit (MPU) or a micro controller unit (MCU)). Furthermore, all or any part of the various processing functions may of course be executed on a program analyzed and executed by a CPU (or a microcomputer, such as an MPU or MCU) or on hardware by wired logic.

According to an aspect, long-term reliability is improved by reduction of heat generation due to optical absorption near an optical input portion.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An optical device, comprising:
a rib optical waveguide formed on a substrate;
a P doped region formed in one of slab regions of the rib optical waveguide;
an N doped region formed in the other one of the slab regions of the rib optical waveguide;
a first electrode connected to the P doped region;
a second electrode connected to the N doped region; and
an optical absorption structure that: implements optical absorption of signal light passing through the rib optical waveguide according to an electric current that flows between the first electrode and the second electrode; and makes, in the optical absorption, the signal light passing through an optical input portion of the rib optical waveguide lower in optical attenuation rate than the signal light passing through at least part of the rib optical waveguide, the part excluding the optical input portion.

2. The optical device according to claim 1, wherein
the first electrode and the second electrode include a material having electric resistance, and
the optical absorption structure has a structure that makes an electric current flowing between the first electrode and the second electrode in the optical input portion smaller than the electric current in an optical output portion of the rib optical waveguide and thereby makes the signal light passing through the optical input portion lower in optical attenuation rate than the signal light passing through at least the part of the rib optical waveguide, the part excluding the optical input portion.

3. The optical device according to claim 2, wherein the optical absorption structure includes:
a first electrode pad connected to the first electrode and arranged near the optical output portion of the rib optical waveguide; and
a second electrode pad connected to the second electrode and arranged near the optical output portion of the rib optical waveguide.

4. The optical device according to claim 3, wherein the optical absorption structure includes:
the first electrode narrower in width than the first electrode pad; and
the second electrode narrower in width than the second electrode pad.

5. The optical device according to claim 2, wherein the optical absorption structure includes:
the first electrode that gradually decreases in electrode width from the optical output portion to the optical input portion; and
the second electrode that gradually decreases in electrode width from the optical output portion to the optical input portion.

6. The optical device according to claim 1, wherein
the P doped region has a P+ doped region formed near a core of the rib optical waveguide and a P++ doped region connected to the first electrode, and
the N doped region has an N+ doped region formed near the core of the rib optical waveguide and an N++ doped region connected to the second electrode.

7. The optical device according to claim 6, wherein
the optical absorption structure includes:
the P+ doped region that gradually increases in width from an optical output portion to the optical input portion of the rib optical waveguide; and
the N+ doped region that gradually increases in width from the optical output portion to the optical input portion, and
the optical absorption structure has a structure that makes an electric current flowing between the first electrode and the second electrode in the optical input portion lower than the electric current in the optical output portion and thereby makes the signal light passing through the optical input portion lower in optical attenuation rate than the signal light passing through at least the part of the rib optical waveguide, the part excluding the optical input portion.

8. The optical device according to claim 1, wherein
the optical absorption structure has an optical waveguide in the rib optical waveguide, the optical waveguide gradually decreasing in waveguide width from an optical output portion to the optical input portion of the rib optical waveguide, and
the optical absorption structure has a structure that makes confinement of the signal light passing through the optical input portion larger than confinement of the signal light passing through the optical output portion and thereby makes the signal light passing through the optical input portion lower in optical attenuation rate than the signal light passing through at least the part of the rib optical waveguide, the part excluding the optical input portion.

9. The optical device according to claim 1, wherein
the optical absorption structure has an undoped optical waveguide that is an optical waveguide in the rib optical waveguide between the P doped region and the N doped region and that gradually increases in waveguide width from an optical output portion of the rib optical waveguide to the optical input portion, and
the optical absorption structure has a structure that makes an electric current flowing between the first electrode and the second electrode in the optical input portion lower than the electric current in the optical output portion and thereby makes the signal light passing through the optical input portion lower in optical attenuation rate than the signal light passing through at least the part of the rib optical waveguide, the part excluding the optical input portion.

10. An optical transmitting device, comprising:
a light source;
an optical modulator that optically modulates light from the light source by using a transmitted signal and transmits transmitted light; and
an optical device that attenuates the light in the optical modulator, wherein
the optical device includes:
a rib optical waveguide formed on a substrate;
a P doped region formed in one of slab regions of the rib optical waveguide;
an N doped region formed in the other one of the slab regions of the rib optical waveguide;
a first electrode connected to the P doped region;
a second electrode connected to the N doped region; and
an optical absorption structure that: implements optical absorption of signal light passing through the rib optical waveguide according to an electric current that flows between the first electrode and the second electrode; and makes, in the optical absorption, the signal light passing through an optical input portion of the rib optical waveguide lower in optical attenuation rate than the signal light passing through at least part of the rib optical waveguide, the part excluding the optical input portion.

11. An optical receiving device, comprising:
a light source;
an optical receiver that receives a received signal from received light using light from the light source; and
an optical device that attenuates the light in the optical receiver, wherein
the optical device includes:
a rib optical waveguide formed on a substrate;
a P doped region formed in one of slab regions of the rib optical waveguide;
an N doped region formed in the other one of the slab regions of the rib optical waveguide;
a first electrode connected to the P doped region;
a second electrode connected to the N doped region; and
an optical absorption structure that: implements optical absorption of signal light passing through the rib optical waveguide according to an electric current that flows between the first electrode and the second electrode; and makes, in the optical absorption, the signal light passing through an optical input portion of the rib optical waveguide lower in optical attenuation rate than the signal light passing through at least part of the rib optical waveguide, the part excluding the optical input portion.
